(19) United States
(12) Patent Application Publication
(10) Pub. No.: US 2004/0108277 A1
(43) Pub. Date: Jun. 10, 2004

(54) Reverse osmosis pretreatment using low pressure filtration

(75) Inventor: Gerald A. Krulik, San Clemente, CA (US)

Correspondence Address: Maria S. Swiatek, DORSEY & WHITNEY LLP, 4 Embarcadero Center, San Francisco, CA, 94111-4187, US

(73) Assignee: Ionics, Incorporated

(21) Appl. No.: 10/199,182

(22) Filed: Jul. 19, 2002

Related U.S. Application Data
(60) Provisional application No. 60/306,696, filed on Jul. 20, 2001.

(51) Int. Cl. B01D 21/01; B01D 61/00

(52) U.S. Cl. 210/723; 210/724; 210/725; 210/650

(57) ABSTRACT

A method for pretreating waste water for use in reverse osmosis filtration is provided. Small amounts of chemicals are added to the waste water to promote formation of filterable particles from colloidal and dissolved solids. These particles are then removed via a closed-end, low pressure, high flowrate filtration system prior to reverse osmosis treatment.

### RELATED APPLICATIONS

This patent application claims the benefit of U.S. provisional patent application Serial No. 60/306,696 filed Jul. 20, 2001, the entire disclosure of which is hereby incorporated by reference.

### FIELD OF THE INVENTION

This invention relates to methods of pretreating water. More specifically, the present invention relates to methods of pretreating water prior to reverse osmosis (“RO”) treatment using low pressure filtration to replace ion exchange.

### BACKGROUND OF THE INVENTION

Current technology for Reverse Osmosis (“RO”) water purification systems rarely allows feed water to be sent directly to the RO unit. Most waste water streams contain a variety of insoluble or potentially insoluble components that can clog and degrade RO purification systems. The most common types of scale forming or precipitable materials which can harm RO membranes are clays, silts, and silica; organic substances such as natural humic acids and other long chain polymers; calcium, magnesium, manganese, and iron; and anions such as phosphates, silicates, sulfates, fluorides, and carbonates. Calcium in particular forms many insoluble compounds.

Current technology consists of a two step pretreatment. The first step is generally a filtration process designed to remove suspended solids. This process often includes chemical treatment such as ferric chloride to precipitate colloidal solids, followed by sand filtration or other filtration and is designed to remove preexisting solids and most colloidal materials. The second step is to remove potentially insoluble components which are dissolved. Some type of ion exchange (IX) technology is typically employed. Either a strong acid/strong base Ion exchange or a weak acid/weak base Ion exchange can be used. The strong Ion exchange system removes most of the ions except silica. The drawback to this approach is the consumption of large amounts of concentrated acid (sulfuric or hydrochloric) and caustic (sodium or potassium hydroxide) required to regenerate the resins. This produces a large volume of concentrated, contaminated acid which is normally neutralized and discharged to the sewer. Weak Ion exchange systems are typically regenerated with sodium chloride instead of acid and base. Such systems are better at removing some materials such as silica, and removes most di and trivalent anions and cations. Weak Ion exchange systems produce a large volume of contaminated highly salty water that must be discharged to the sewer. Both approaches consume large amounts of chemicals to remove relatively small amounts of harmful compounds. Either type of Ion exchange system is disadvantageous if the goal of the wastewater treatment system is to maximize water recycling or even achieve zero liquid discharge.

Accordingly, there is a need for a method of a single step reaction and filtration process, which uses minimum chemical addition and provides removable solid precipitates. There is also a need to avoid production of concentrated liquid wastes from large volumes of ion exchange regenerates. There is a further need for maximum water recycling to achieve the goal of zero liquid discharge.

### SUMMARY OF THE INVENTION

It is an object of the present invention to provide a method and system of pretreating water prior to reverse osmosis treatment using low pressure filtration.

In accordance with the present invention, there is provided a method of treating wastewater prior to reverse osmosis treatment. The method comprises providing a wastewater containing precipitable materials harmful to reverse osmosis membranes, adjusting the pH of the wastewater to a range from about 6 to about 8, adding a flocculating agent to the wastewater to form precipitated particles, and removing the precipitated particles from the wastewater prior to reverse osmosis treatment.

The flocculating agent used in the present method includes organic and inorganic flocculating agents. The organic flocculating agent can be selected from the group consisting of polyacrylamides (cationic, nonionic, and anionic), epichlorohydrin/dimethylamine (epi-dma) polymers, polydiallydimethylammonium chlorides (DADMAC), and copolymers of acrylamide and DADMAC. The inorganic flocculating agent can be selected from the group consisting of soldium aluminate, aluminum chloride, polyaluminum chloride, iron chloride, aluminum sulfate, polyaluminum sulfate, potassium aluminum sulfate, ferric potassium sulfate, and natural guar.

The precipitable materials to be removed from wastewater prior to reverse osmosis include clays, silts, silica, natural humic acids, organic polymers, calcium, magnesium, strontium, barium, barium, manganese, iron, phosphates, silicates, fluorides, and carbonates.

The present method can be carried out by using filtration under low pressure (in one example about 9 psi and less) to remove the precipitated particles. In particular, the filtration comprises the steps of pumping the wastewater at a low flow rate through an array of flexible filter media so that the precipitated particles are accumulated on the surfaces of the filter media. The backpressure and total filtration time are monitored until one parameter exceeds a predetermined limit. The wastewater input is temporarily stopped when the predetermined limit for backpressure or total filtration time is exceeded. A small reverse flow pulse is then provided to flush the filtration media and dislodge the accumulated particles. The dislodged particles are collected and discharged to a sludge holding tank. The wastewater input is resumed until the predetermined limit for backpressure or total filtration time is exceeded.

### BRIEF DESCRIPTION OF THE DRAWINGS

Other objects and advantages of the present invention will become apparent upon reading the detailed description of the invention and the appended claims provided below, and upon reference to the drawings, in which:

FIG. 1 is a schematic showing a system which may be used to carry out the method of the present invention.

FIG. 2 is a Pourbaix diagram for Cu—H₂O system.

FIG. 3 is a chart of a low pressure filtration process data showing influent turbidity from high silica/iron mixed CMP wastewater treatment.

FIG. 4 shows low pressure filtration process data illustrating filtered turbidity from high silica/iron mixed chemical mechanical polishing (“CMP”) wastewater treatment.

FIG. 5 is a chart illustrating residual silica concentrations after low pressure filtration of a mixed CMP wastewater stream.

FIG. 6 is a chart showing automatic fluoride removal data for treatment of an influent waste stream at a concentration of 10 ppm.

FIG. 7 is a chart showing automatic fluoride removal data for treatment of a high fluoride concentration pulse of wastewater from a semiconductor fabrication process.

FIG. 8 is diagram illustrating Zero Liquid Discharge waste management according to one embodiment of the invention.

### DETAILED DESCRIPTION OF THE INVENTION

The present invention provides a method of pretreating wastewater prior to reverse osmosis (RO) treatment of the wastewater. The pretreatment of the wastewater removes precipitable materials that are harmful to RO membranes. In particular, the pretreatment method of the present invention comprises adding a flocculating agent to the wastewater to form removable solid precipitated particles, and removing the precipitated particles from the wastewater by filtration under low pressure. This single step reaction and filtration process eliminates the need of ion exchange process prior to reverse osmosis treatment, thus eliminating production of concentrated liquid waste from large volumes of Ion exchange regenerates.

The flocculating agent used in the present method includes organic and inorganic flocculating agents. The organic flocculating agent can be selected from the group consisting of polyacrylamides (cationic, nonionic, and anionic), epichlorohydrin/dimethylamine (epi-dma) polymers, polydiallydimethylammonium chlorides (DADMAC), and copolymers of acrylamide and DADMAC. The inorganic flocculating agent can be selected from the group consisting of soldium aluminate, aluminum chloride, polyaluminum chloride, iron chloride, aluminum sulfate, polyaluminum sulfate, potassium aluminum sulfate, ferric potassium sulfate, and natural guar.

The most common types of scale forming or precipitable materials which can harm RO membranes are clays, silts, and silica; organics such as natural humic acids and other long chain polymers; calcium, magnesium, strontium, barium, manganese, and iron; and anions such as phosphate, silicate, sulfate, fluoride, and carbonate. Calcium in particular gives many insoluble compounds.

The waste treatment process of the present invention uses a combination of organic and inorganic flocculating agents to precipitate most of these materials. Silica and large organic polymers and colloids are almost completely removed. Iron and manganese are completely removed as the oxides. Calcium, barium, strontium can be removed as a complex aluminum silicate precipitates, along with dissolved silicates, phosphates, and some fluorides and carbonates. Barium and strontium may also be removed as sulfates or carbonates. Magnesium may also be removed as a silicate or aluminum silicate precipitates. The remaining ions are predominantly carbonates/bicarbonates and sulfates.

Neither carbonates/bicarbonates nor sulfates are easily precipitated, but neither are harmful to RO membranes if the concentration of precipitable co-ions, such as calcium and magnesium, is sufficiently low. Further, bicarbonates are much more soluble than carbonates. The process can be used at pH less than 8, to maintain the carbonate equilibrium to favor more soluble bicarbonates. The process also takes advantage of the fact that, at neutral pH, hydrous oxide precipitates such as ferric hydroxide and aluminum hydroxide can absorb and adsorb large numbers of both anions and cations from solution.

The composition of the water supply determines what type of chemistry will be most useful. In many cases, such as when silica and colloidal organics are the main concern, only sodium aluminate and an organic flocculating agent are needed, along with precise pH control. In other cases poly-aluminum chloride, aluminum chloride, and iron chloride, alone or in combination with each other, are used and followed by one or more of sodium aluminate and an organic flocculating agent. Carbon dioxide, acids, bases, sodium carbonate, sodium silicate, etc, may be used as necessary to form insoluble particles prior to the RO process, and to adjust the pH to the optimum for precipitation and removal of such particles.

The present method of pretreating wastewater is advantageous over the prior art method such as ion exchange. Ion exchange generates a liquid waste stream. The regenerate for the Ion exchange system must be of higher ionic strength than the treated wastewater. Thus, 5% (volume %) acid or base or a solution of 1-2 pounds per gallon of sodium chloride are used for regeneration of strong Ion exchange and weak Ion exchange systems, respectively. Upon mixing and neutralizing of the regenerate acid and base solutions for discharge, large amounts of solids and concentrated salt solutions are produced. Such mixtures are discharged to the sewer because their ionic strength is much too high for most RO systems, even after removal of suspended solids to reduce RO membrane clogging. Thus, the usual filtration plus Ion exchange pretreatment system for RO negates many of the advantages of the RO system itself by requiring addition of large amounts of chemicals, producing large volumes of concentrated liquid waste, and making recycle and zero liquid discharge waste treatment much more difficult.

The method of the present invention is a pre-RO water purification approach that uses small amounts of chemicals in a low pressure (about 9 psi and lower) filtration process. Small amounts of iron and/or aluminum salts, in combination with small amounts of highly charged organic polymer flocculating agents, can remove sufficient suspended and dissolved solids to allow the feed water to be processed by RO without further chemical treatment. The particles formed are then easily filterable solid. Because the present invention provides a precipitation process, only small amounts of solids are produced. Of particular advantage the reactions preferably generate large non-sticky filterable solids to remove both pre-existing colloidal and other suspended solids; precipitable ions such as metals, silica, calcium silicate, barium sulfate, strontium sulfate, calcium fluoride; and precipitable organic materials. No large volumes of liquid waste are produced, only small amounts of solids that are readily filtered and dewatered. The treated liquid, free of significant amounts of precipitable materials, is suitable for purification with RO, especially since the total dissolved solid content of the treated water is not increased appreciably by the method of the present invention.

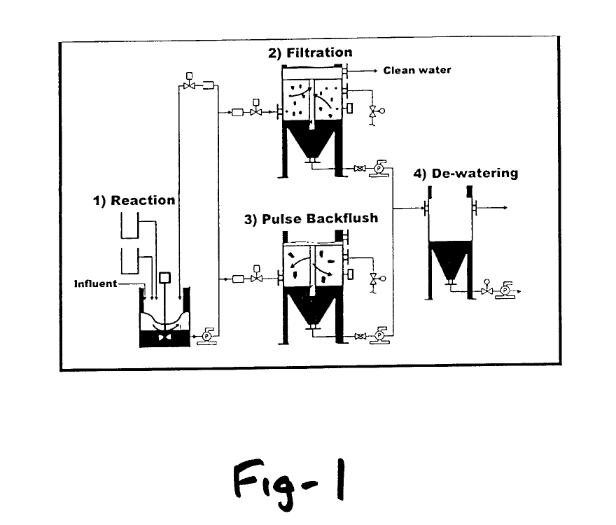

In one embodiment, the present filtration method can be carried out by the system illustrated in FIG. 1. While a particular system is shown for illustrating purpose, the pretreatment method of the present invention is not so limited. Other filtration systems can also be used to carry out the pretreatment method of the present invention. In this particular embodiment, the wastewater after being pretreated with flocculating agents is pumped at a flow rate through an array of flexible filter media so that precipitated particles are accumulated on the surfaces of the filter media. The backpressure and total filtration time are monitored by computer controls until one parameter exceeds a predetermined limit. The predetermined limit depends on the solid content of the water and the minimum tolerable system flow rate. The wastewater input is temporarily stopped when the predetermined limit for backpressure or total filtration time is exceeded. Then a small reverse flow pulse is provided to flush the filtration media and dislodge the accumulated particles. The dislodged particles are collected and discharged to a sludge holding tank. The wastewater input is resumed until the predetermined limit for backpressure or total filtration time is exceeded.

Of one advantage, the pretreatment method of the present invention to remove precipitable ions fits into any suite of techniques which may be employed in a strategy designed to provide a high percentage of wastewater recycle, up to and including zero liquid discharge reclaim systems. The effluent can be used without further purification in many scrubber and cooling systems. However, soluble ions and organics are not removed.

The system and method of the present invention can be an integral part of zero liquid discharge (ZLD) strategies for minimizing both waste water discharges from, and fresh water inputs to, manufacturing processes. A novel method of economical treatment of organic materials, using the present invention in combination with RO and biological treatment processes is presented. Water from CMP processes can be recycled directly to RO with high efficiency, and high total dissolved solids (TDS) streams can be diverted to other process loops to give high efficiency water recycle.

A major aspect of any wastewater treatment is the separation of solids from liquids, whether the liquid is then further treated, recycled, or sewered. Especially in a zero liquid discharge plant, the waste must consist of a large amount of solids. Typical existing solids in the wastewater include alumina, copper hydroxide, iron hydroxide, silica, silicon, tungsten, background residues, and photoresist residues. Many other dissolved or colloidal materials can also be converted to insoluble particles for ease of removal. This includes arsenic, heavy metals such as copper, iron, nickel, lead, tungsten, and tin, phosphates, silicates, and fluorides. As water undergoes successive separation and concentration steps, solids must be removed from the high TDS liquids.

Pre-existing semiconductor fabrication and other manufacturing process wastes are amenable to treatment with the process of the current invention. Any other dissolved or colloidal wastes that can be converted to solids are also filtered. All solids are modified by the chemical treatment to convert them to large, hard, non-sticky, easily filterable solids.

FIG. 1 shows the equipment and operating schematic for one embodiment of the current invention. One or more reaction tanks are used to generate solids, if needed (arsenic, fluoride, and heavy metals). The system is generally comprised of four stages; namely: reaction I, filtration 2, pulse backflush 3 and de-watering 4. Wastewater influent is pumped to a reaction tank 10. Flocculants and/or coagulants are added to the reaction tank 10 to give large, non-sticky, hard particles. The wastewater is then pumped at low pressure into the bottom of the filtration vessel 12. Preferably the filtration vessel 12 includes an array of filters 14 having flexible sock membranes over tubular supports (not shown). Preferably the filtration vessels is of the type described further in U.S. Pat. Nos. 5,871,648 and 5,904,853, the entire disclosures of which are hereby incorporated by reference.

Filtered water passes upward through the array of flexible sock membranes over tubular supports. The particles accumulate on the surface of the membrane since they are now too large to penetrate the filter. Commercially available computerized controls monitor the backpressure and the accumulated filtration time within the filter vessel 12. When either parameter setpoint is met, the wastewater input is stopped. The parameter setpoints may be selected based on the type of filtration system employed. In a preferred embodiment of the invention, the backpressure parameter is set at about 9 psi, and lower, or more preferably the parameter is selected in the range of about 8 to 6 psi. A small pump gives a reverse filtration pulse to flex the membrane filters and dislodge the accumulated particles in filtration vessel 12 shown in stage 3. The solids drop to the bottom of the filter vessel, where they are discharged to the sludge holding tank 16. The whole cleaning process may take less than two minutes.

Semiconductor fabrication wastes comprise a varied mixture. Each fab has a unique signature, dependent on the presence and type of CMP processing solutions, arsenic usage, and metals, if back end processing or copper is used. The wastewater consists of a constantly changing mixture of solids and dissolved materials. The main need to process CMP waste waters is an efficient, robust solid removal method that can handle constantly changing solid contents and compositions.

CMP wastes are typical of advanced fab wastes. The major component is particles of silica, which may have a dispersing agent included. CMP process solutions use a very small particle size silica. During use of a CMP solution, rinsing and dilution, pH changes, and mixtures with other chemical wastes generate particles in a wide range of sizes, dissolved silica (silicates, fluorosilicates), and colloids. These waste water components can rapidly clog traditional filters.

Tungsten CMP solutions often consist of a mixture of ferric nitrate and alumina solids. pH adjustment gives a mixture of iron hydroxides and other solids. Iron hydroxides are some of the most difficult materials to filter, especially in the high concentrations found in CMP waste waters. Indeed, the list of possible materials that can be found in CMP solutions is large and continues to grow as shown below in Table 1.

TABLE 1
Inorganic and organic materials found in CMP processes and wastewater.
Inorganic Materials

Interconnect: Cu²⁺, complexed Cu²⁺, Cu₂O, CuO, Cu(OH)₂, WO₃,
Al₂O₃, Al(OH)₃,
Barrier/Liner: Tantalum and titanium oxides and oxynitrides
Abrasives: SiO₂, Al₂O₃, MnO₂, CeO₂
Oxidizers: hydroxylamine, KMnO₄, KIO₄, H₂O₂, NO₃⁻
Strong acids and weak buffering acids: HF, HNO₃, H₂SO₄, HCl, H₃BO₃,
NH₄⁺
Strong bases: NH₃, OH⁻, TMAH, choline base

Organic Materials

Dispersants/surfactants: poly(acrylic acid). quaternary ammonium salts,
alkyl
Corrosion inhibitors: benzotriazole, alkyl amines
Metal chelators: EDTA, ethanol amines, oxalic and citric acid
Acids: poly(acrylic), oxalic, citric, acetic, peroxyacetic
Polymers: low K dielectrics

All of these wastes may be filtered when treated with a synergistic mixture of organic and inorganic flocculating agents of the present invention. These synergistic mixtures use only small amounts of chemicals, and are effective on wide ranges of particle types and solids loadings. The treatment process is extremely robust, as wide changes in wastewater loadings are automatically processed. Likewise, if the basic CMP process chemistry changes, the chemical additions can easily be modified to accommodate this.

Metals are another potential concern in a semiconductor fab. The chief future problem seems to be copper. There are generally three sources for copper. One is the copper electroplating tool, which uses concentrated copper sulfate plating solution. The rinse waters are more dilute but have far more copper than discharge limits. In the US, the copper electroplating tool wastes must be segregated and treated separately as they are considered to be characteristically hazardous wastes. Preferably, a dedicated equipment which converts this type of copper waste into solid copper is employed such as that offered by Microbar, Inc (Sunnyvale, Calif.), giving less than 1 ppm copper discharge after final ion exchange treatment.

The other two types of copper waste are better treated by low pressure filtration due to the solids content of the waste. The U.S. EPA considers non-electroplating copper wastes to be non-hazardous as long as the total amount of copper in the solids does not exceed 25,000 ppm total or 5000 ppm extractable.

A second source of copper is from the CMP polishers. Copper is electroplated on the wafer to a thickness of about 5 microns. This copper is then polished off in the CMP process, giving a mixture of solid and dissolved copper along with any polishing solids. Almost all of the electroplated copper is removed by the polisher. A 300 mm wafer with 5 microns copper thickness will typically have about 0.35 cm³ or 3.15 grams of copper.

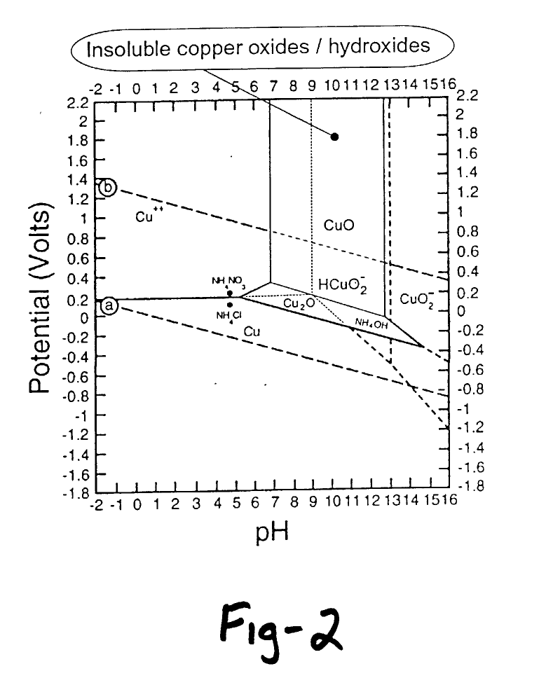

At first glance, metals may not appear to be a great problem. Most metals precipitate fairly well at pH 6-8, though a few such as nickel precipitate better at higher pH. Some metals are amphoteric, but most do not show significant solubility at both high and low pH. A Pourbaix diagram is a shorthand visual summary of all known reduction-oxidation and solubility equilibria over the full range of aqueous electrode potentials and pH. FIG. 2 shows the Pourbaix diagram for copper in the absence of chelating agents. Lines (a) and (b) indicate the upper and lower electrical stability limit for water at each pH. This shows that, in the absence of chelating agents, copper will form insoluble compounds around pH 7.

A third source of copper is from the cleaning step. This can contain ammonia, chelating agents, fluorides, surfactants, and other chemicals. Most waste waters from copper CMP processes, especially cleaners, contain inorganic and organic materials that complex with metals. This inhibits precipitation and removal of copper or other metals. An effective wastewater treatment method must be capable of both removing the solid metals and/or compounds, and of precipitating any dissolved metals. Fortunately, there is a long chain polymeric precipitating agent that is compatible with single pass, low pressure filtration. It can remove copper down to less than 0.1 ppm. Other heavy metals are similarly removed. The excess polymeric precipitating agent is totally removed in the final solids modification step.

The final solid modification process is used regardless of the types of solids that are present. The method of the present invention employs additives to flocculate and modify wastewater solids. An organic flocculant is effective at very low concentrations, while an inorganic flocculent continues to enlarge the particles as it makes them hard and non-sticky. The combination of the two components is effective over an extremely wide range of solids inputs, while leaving non-detectable residual organic flocculent (far less than of 1 ppm).

This process is also effective at removing materials that do not strictly precipitate, such as arsenic. Arsenic is removed by absorption onto ferric hydroxide gel at controlled pH:

FeCl₃+NaOH═Fe(OH)₃+NaCl

Fe(OH)₃)_{y}+AsO₄³⁻═(Fe(OH)₃)_{y-3}(AsO4³⁻)+3OH⁻

Arsenate absorption is so strong that it can be removed to less than 1 ppb at pH 7-8 even in the presence of peroxide, Cl⁻, SO₄²⁻, ammonia, and metals. The normal problem with this process is that iron hydroxides are among the most difficult of materials to filter. The flocculation process converts the iron hydroxide to non-sticky, easily filterable materials. Low pressure filters have operated in excess of one year without fouling. This is a much easier and cheaper process than centrifugation, which is often suggested for difficult to filter wastes such as iron hydroxides.

Another candidate for low pressure filtration is fluoride treatment, which is preferably carried out a pH range of about 6 to 8.

CaCl₂+2HF⁻═CaF₂+2HCl

2NaOH+2HCl=2NaCl+2H₂O

Traditional precipitation methods using settling ponds suffer from the need for large volumes and slow flow rates, yet still usually have significant carryover of solids. Likewise, fluoride crystallization units need to have the input fluoride closely monitored and controlled within a narrow pH range, at about 300-1000 ppm. Automatic fluoride treatment with low pressure filtration will eliminate those problems. Fluoride treatment is simple on flowing waste waters with up to 500-10,000 ppm of fluoride.

In another aspect, the present invention may be employed with a zero liquid discharge (ZLD) system. Zero liquid discharge does not imply 100% water recycle. Water is lost by evaporation in cooling and fume scrubbing systems, and from water entrained in solid wastes. However, all remaining water is recycled to limit fresh water input. Typically, a ZLD system includes a hierarchy of treatment methods and corresponding splits of treated water to different types and classes of reuse and recycle. However, the majority of the water must be converted back to ultrapure water (UPW) for general manufacturing use. This approach does entail some practical difficulties: the sum total of the treatment processes must remove all solids, ions, organics, non-ionic materials, and gases from the liquids. The processes must be economical, highly automated, reliable, and capable of being integrated together. Another consideration focuses on specific chemical treatments for each class of compound, or rather on treatment processes that remove multiple pollutant species simultaneously.

Some materials are readily removed, at least by low pressure filtration. These include pre-existing solids, metals, photoresist and low-K dielectric residues, silica and silicon, and any precipitable materials. Most existing semiconductor waste water treatment processes currently remove the great majority of these materials. Unfortunately, many other materials typically present in semiconductor process and other industrial waste waters are substantially more difficult to remove to regenerate UPW. These include traces of ammonia, nitrates, chlorides, low molecular weight organics, solvents, sodium and potassium salts, sulfate, surfactants, and biological contamination. These materials can be concentrated, but a goal is to form solids. A practical plant design has to examine all the technical and economic tradeoffs to determine the precise role of, say, vacuum evaporation as the final solids generation step versus the type and number of processes which will give the high TDS liquids for evaporation.

The method of the present invention has been implemented to treat a large part of some difficult CMP wastewater residues. The filtration system output is coupled with reverse osmosis (RO) to produce a concentrated organic waste (RO Reject) for biological treatment. Biological treatment employing a biopond can be used to remove ammonia, nitrates, organics, solvents, and surfactants. The treated wastewater from the biopond contains traces of sodium and potassium salts, sulfates, chlorides, and biological contamination. Almost everything else will have been converted to gases or solids.

The liquid output from a biopond is filterable and recyclable. As another example, concentrated fluoride treatment wastes are normally sewered after treatment. They have a high total dissolved solids and residual calcium, so are not practically treatable with RO. Some ZLD approaches designate this waste as a candidate for evaporation and solidification. A lower cost option is to send the residual liquid to a biological treatment pond, where most of the calcium and trace organics will be removed. The biopond liquids is then filtered, and treated with RO to generate a concentrated RO reject for evaporation and solidification. This is typical of the cost/benefit decisions which must be evaluated for ZLD approaches.

There are a number of traditional reuse options for dilute wastewater. Treated and filtered CMP wastewater can be used with no further processing for scrubbing and cooling applications. Filtered wastewater can be combined with city water input directly, as part of makeup water. Filtered wastewater can be coupled to reverse osmosis to give higher purity water, then combined with city water for higher input quality. All of these purposes are compatible with the present invention, as is shown by the data presented in the Experimental section below.

### Experimental

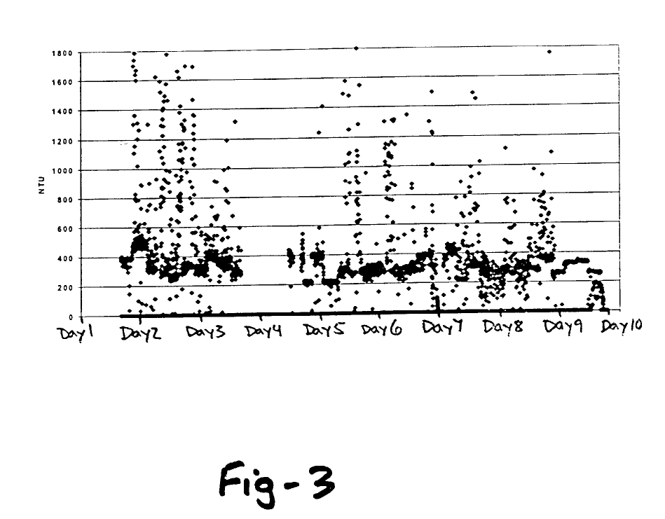

The following experiments are presented for illustration purposes only and are not intended to limit the invention in any way. Waste water was treated in a single pass, without recirculating, at 3-15 psig (0.2-1 atm) with a flux of 100-500 gal/ft²/day (4-20 m³/m²/day). Systems are available from 2 to 10,000 gal/min (0.5-2300 m³/hr). FIGS. 3 to 5 demonstrate the effectiveness of the process of the present invention for reducing suspended solids concentrations in high silica CMP waste water. FIG. 3 shows part of the range of incoming turbidity from mixed silica and iron CMP waste water over time. The maximum turbidity values spiked on occasion to 8000 ppm, but the turbidity axis is truncated to 2000 ppm to improve resolution for lower concentration data. FIG. 4 shows the turbidity results after treatment. The average treated turbidity was less than 0.2 ppm, which compares favorably to the U.S. EPA drinking water limits of 0.5-5 ppm turbidity. The key point here is that all of these different solids contents were treated automatically with one mixture of two treatment chemicals.

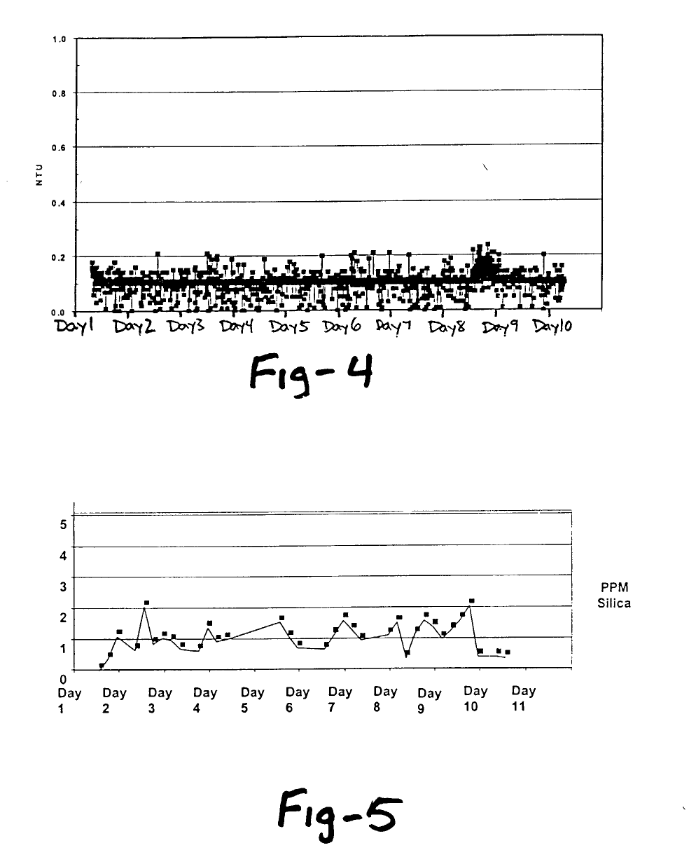

FIG. 5 shows the residual silica after treatment. The silica averaged less than 2 ppm, despite incoming silica ranging from 200 up to 3376 ppm. One key advantage of the present invention is that silica is removed by chemically efficient flocculation rather than mass balance type precipitation. These results were generated using an automatic 5 gpm (18.7 liters/minute) flowrate in the filtration system.

FIG. 6 shows the output from a system of the present invention of less than 10 ppm fluoride, as the input fluoride varied from 100 to 900 ppm.

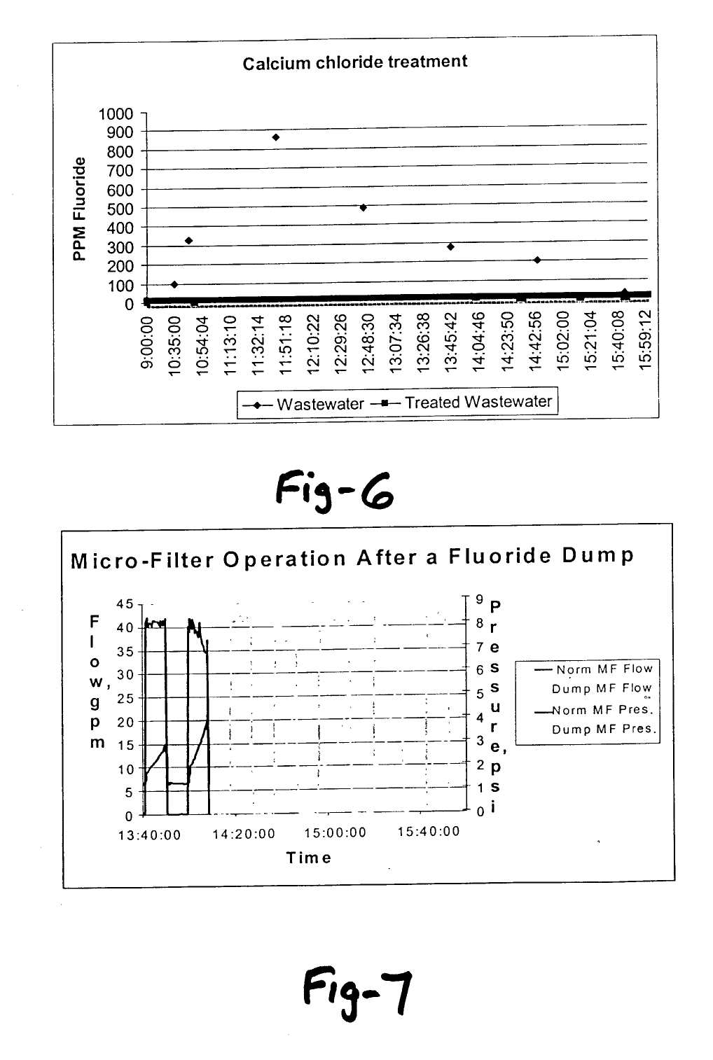

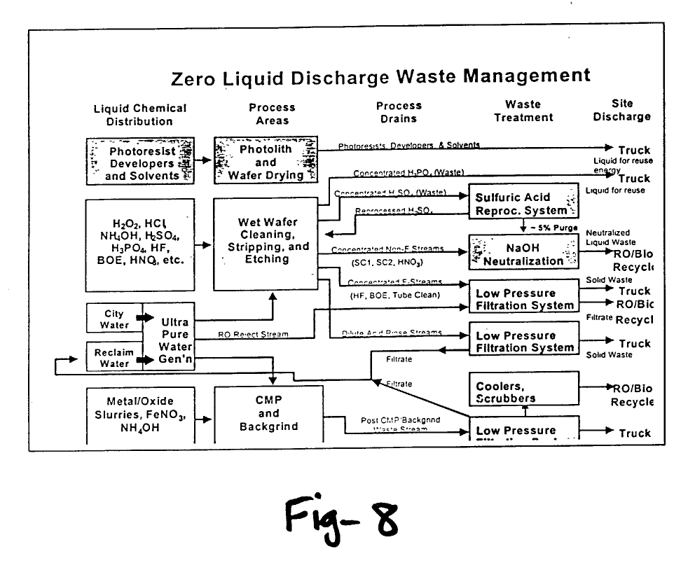

FIG. 7 shows the low pressure filtration versus time curves for another embodiment of the present invention. This unit experienced a large fluoride dump. The first two curves show the filter pressure prior to the large dump. The other curves show the maximum pressure reached during fluoride dump treatment, and show then how the pressure returned quickly back to normal. The high flow rate was maintained throughout the process.

Table 2 shows the major ions from an untreated (Input) and treated (Day 1, etc) mixed CMP fab wastewater. This wastewater was automatically treated using computerized control. Experiments were conducted and data are shown for six or seven consecutive days from the first week of an eight week test. The wastewater treatment test ran 24 hours per day, 7 days a week, for the 8 weeks except for one 3 day holiday shutdown. Most of the minor elements were not detected at the detection limit of 0.1-0.01 ppm. These ions included Ag, As, B, Ba, Cd, Cr, Li, Mn, Ni, Pb, Se, Ta, W, and Zn.

TABLE 2
Major inorganic materials found in mixed CMP wastewater, before and
after filtration.
LOW PRESSURE FILTRATION OF MIXED CMP WASTEWATER

| ION | INPUT | DAY 1 | D2 | D3 | D4 | D5 | D6 |
|---|---|---|---|---|---|---|---|
| Al | 65 | 6 | 3 | 2.5 | 4 | 2.6 | 4.8 |
| Ca | <1 | 2 | 2 | 3 | 3 | 5 | 4 |
| Cu | 2.5 | 1.36 | 0.91 | 0.81 | 0.81 | <0.05* | <0.05* |
| Fe | 70 | <0.02 | <0.02 | <0.02 | <0.02 | <0.02 | 0.18** |
| K | 4 | 16 | 6 | 7 | 9 | 8 | 10 |
| Na | 5 | 100 | 131 | 128 | 138 | 129 | 142 |
| Si | 900 | 0.8 | 1.0 | 0.3 | 0.3 | 0.4 | 0.4 |
| Sr | <0.01 | 0.1 | 0.11 | 0.12 | 0.09 | 0.16 | 0.17 |
| Chloride | 10 | 37 | 37 | 39 | 41 | 38 | 38 |
| Fluoride | — | 0.3 | 0.3 | 0.4 | 1.5 | 0.4 | 0.4 |
| Nitrate | 250 | 196 | 199 | 230 | 209 | 208 | 237 |
| Sulfate | 25 | 37 | 36 | 29 | 37 | 45 | 42 |

All results are in ppm
*Polymeric copper precipitating agent added, days 5 and 6
**Customer added large amount of complexing agent to challenge the system

The data shows that the treated wastewater is compatible with many applications for reuse or recycle. The residues of calcium and other metals are below concentrations expected to present a problem with RO treatment. Sodium salts (chloride, sulfate, and nitrate) are the only appreciable chemicals left from mixed silica/ferric nitrate CMP treatment.

There are additional materials that have not yet been discussed. For example, no mention has been made of organic chemicals, including solvents, chelating agents, surfactants, and dispersants. Ammonia is also found in all fab waste streams, while nitrates come from tube cleans, and some metals CMP. These are not necessarily all compatible with RO systems, and some like nitrates can be difficult to remove completely. Total evaporation and recovery of the whole filtered wastewater stream may be too costly to remove these materials. A multi-step process is more likely to be useful.

A substantial concern with biological treatment is the size and cost of such a system. Biological treatment is usually slower than chemical treatment, but biological treatment removes many materials that conventional precipitation and filtration cannot remove. The size of a biological treatment system could be greatly reduced if low pressure filtration, RO, and biological treatment were coupled together.

A low pressure filtration pilot system was tested for this application, by feeding the output directly into a two pass RO system. The RO was operated at 50-80% recovery under different conditions using thin film membranes. Table 3 shows RO product water analyses from combing low pressure filtration with RO, for the same fab wastes shown in Table 2. The RO product water is suitable for use in scrubbers and coolers, or for recycle. The only appreciable solids in the RO product water is a small amount of sodium nitrate and sodium chloride.

TABLE 3
Major inorganic materials found in RO Product water, from
treatment of mixed CMP wastewater using filtration.
RO PRODUCT WATER USING FEED FROM LOW PRESSURE
FILTRATION OF MIXED CMP WASTEWATER

| ION | DAY 1 | D2 | D3 | D4 | D5 | D6 | D7 |
|---|---|---|---|---|---|---|---|
| Al | 0.1 | <0.05 | 0.4 | <0.05 | <0.05 | <0.05 | <0.05 |
| Ca | 0 | 0.1 | 0 | 0 | 0 | 0 | 0 |
| Cu | <0.05 | <0.05 | 0.07 | <0.05 | <0.05 | <0.05 | <0.05 |
| Fe | 0.02 | <0.02 | 0.04 | <0.02 | <0.02 | <0.02 | <0.02 |
| K | 0 | 0 | 0 | 0 | 0 | 0 | 0 |
| Na | 18.3 | 18.4 | 18.2 | 29.2 | 32 | 5.5 | 3 |
| Si | 0.66 | <0.10 | 3.12 | 0.09 | 0.08 | 0.06 | 0.08 |
| Sr | <0.01 | <0.01 | 0.15 | <0.01 | <0.01 | <0.01 | <0.01 |
| Chloride | 2.3 | 5.4 | 5.5 | 5.6 | 5.5 | 6.3 | 6.6 |
| Fluoride | 0.9 | 1.2 | 0.8 | 0.9 | 0.8 | 0.3 | 0.3 |
| Nitrate | 81 | 85 | 95 | 96 | 102 | 74 | 79 |
| Sulfate | 0.0 | 0.0 | 0.0 | 0.0 | 0.0 | 0.0 | 0.0 |

All results are in ppm

The RO reject was concentrated wastewater from the RO. It contained most of the ammonia, sulfate, chloride, sodium, and nitrates, and almost all of the organic material-surfactants, chelating agents, organic acids, and other materials-in a much smaller volume of waste water. Table 4 shows the major ions that were concentrated into this waste stream. Note that no effort was made to maximize the concentration factor, so higher concentrations are possible.

TABLE 4
Major inorganic materials found in RO Reject water, from treatment
of mixed CMP wastewater using filtration.
RO REJECT USING FEED FROM LOW PRESSURE FILTRATION OF
MIXED CMP WASTE WATER

| ION | DAY 1 | D2 | D3 | D4 | D5 | D6 | D7 |
|---|---|---|---|---|---|---|---|
| Al | 1.2 | 0.5 | 0.4 | <0.05 | <0.05 | <0.05 | <0.05 |
| Ca | 2.3 | 2.8 | 8.9 | 14.9 | 16 | 24 | 21.7 |
| Cu | 0.1 | 0.01 | 0.07 | <0.05 | <0.05 | <0.05 | <0.05 |
| Fe | 0.02 | <0.02 | 0.04 | 0.04 | <0.02 | 0.04 | 0.04 |
| K | 21.9 | 18.4 | 19.8 | 19.9 | 16.5 | 21.5 | 21.5 |
| Na | 261 | 209 | 220 | 220 | 196 | 303 | 222 |
| Si | 1.16 | 0.62 | 3.12 | 0.25 | 1 | 0.73 | 0.94 |
| Sr | <0.01 | 0.08 | 0.15 | 0.25 | 0.3 | 0.46 | 0.46 |
| Chloride | 99 | 91 | 92 | 107 | 105 | 109 | 105 |
| Fluoride | 2.0 | 2.8 | 1.9 | 2.7 | 2.7 | 7.0 | 7.5 |
| Nitrate | 510 | 391 | 431 | 378 | 365 | 452 | 476 |
| Sulfate | 11.0 | 12.7 | 12.8 | 13.4 | 23.5 | 13.4 | — |

All results are in ppm

The same samples were also tested for the total of all dissolved materials (TDS), and for total organic carbon (TOC). TOC is important in UPW recycle since current specifications call for TOC to be less than 50 ppb, often much less. The data show minimal dissolved solids in the RO product water, and almost no TOC. This RO product water is perfectly suitable for mixing with incoming city water, to make plant UPW. The quality of this RO product water is far superior in terms of contamination level and reproducibility, to the randomly varying water supply that most fabs have to treat.

TABLE 5
Reverse osmosis pilot data showing concentration of TOC
and dissolved solids, at 50% recovery.
RO TREATMENT USING FEED FROM LOW PRESSURE
FILTRATION OF MIXED CMP WASTEWATER

| | | | | | | |
|---|---|---|---|---|---|---|
| DAY 1 | D2 | D3 | D4 | D5 | D6 | D7 |

Output of low pressure filtration

| | | | | | | | |
|---|---|---|---|---|---|---|---|
| TOC | 21 | 22 | 27 | 25 | 25 | 26 | 41 |
| TDS | 466 | 480 | 530 | 490 | 510 | 550 | 490 |

RO Reject water

| | | | | | | | |
|---|---|---|---|---|---|---|---|
| TOC | 17 | 11 | 9.4 | 14 | 17 | 20 | 26 |
| TDS | 717 | 740 | 600 | 740 | 810 | 960 | 840 |

RO Product water

| | | | | | | | |
|---|---|---|---|---|---|---|---|
| TOC | <1 | <1 | <1 | <1 | <1 | <1 | <1 |
| TDS | 37 | 66 | 100 | 77 | 97 | 77 | 91 |

All results are in ppm

The data in Table 5 also show that almost all of the organic materials were concentrated in the reject stream, along with most of the inorganic dissolved solids. Bioponds work better with higher concentration wastes, so this is an easy way to remove the TOC. The TDS also contains ammonia and nitrates, which are difficult to remove with conventional treatment, but simple to remove with bioponds.

Another embodiment of the present invention is shown in FIG. 8, illustrating a system and approach to a goal of zero liquid discharge, showing how precipitation, low pressure filtration, RO, and biopond treatment may be useful.

The foregoing description of specific embodiments and examples of the invention have been presented for the purpose of illustration and description, and although the invention has been illustrated by certain of the preceding examples, it is not to be construed as being limited thereby. They are not intended to be exhaustive or to limit the invention to the precise forms disclosed, and obviously many modifications, embodiments, and variations are possible in light of the above teaching. It is intended that the scope of the invention encompass the generic area as herein disclosed, and by the claims appended hereto and their equivalents.

What is claimed is:

1. A method of pretreating wastewater prior to reverse osmosis treatment, comprising
providing a wastewater containing precipitable materials harmful to reverse osmosis membranes;
adjusting the pH of the wastewater to a range from about 6 to about 8;
adding a flocculating agent to the wastewater to form precipitated particles of the precipitable materials; and
removing the precipitated particles from the wastewater prior to the reverse osmosis treatment.

2. The method of claim 1 wherein the flocculating agent comprises an organic and an inorganic flocculating agent.

3. The method of claim 2 wherein the organic flocculating agent is comprised of polyacrylamides (cationic, nonionic, and anionic), epichlorohydrin/dimethylamine (epi-dma) polymers, polydiallydimethylammonium chlorides (DADMAC), or copolymers of acrylamide and DADMAC.

4. The method of claim 2 wherein the inorganic flocculating agent is comprised of soldium aluminate, aluminum chloride, polyaluminum chloride, iron chloride, aluminum sulfate, polyaluminum sulfate, potassium aluminum sulfate, ferric potassium sulfate, or natural guar.

5. The method of claim 1 wherein the precipitable materials to be removed prior to reverse osmosis include clays, silts, silica, natural humic acids, organic polymers, calcium, magnesium, strontium, barium, barium, manganese, iron, phosphates, silicates, fluorides, and carbonates.

6. The method of claim 1 wherein the precipitable materials are silica and colloidal organic polymers, and the flocculating agent is sodium aluminate and an organic flocculating agent.

7. The method of claim 1 wherein the step of removing precipitated particles is performed by filtration under pressure of about 9 psi and less.

8. The method of claim 7 wherein said filtration comprises the steps of:
pumping the wastewater through an array of flexible filter media, said flexible filter media accumulating precipitated particles on their surfaces;
monitoring the backpressure and total filtration time until one parameter exceeds a predetermined limit;
temporarily stopping wastewater input when the predetermined limit for backpressure or total filtration time is exceeded;
providing a small reverse flow pulse to flex the filtration media and dislodge accumulated particles;
collecting and discharging the dislodged particles to a sludge holding tank; and
resuming wastewater input until said predetermined limit for backpressure or total filtration time is exceeded.

9. A method of treating waste water, comprising:
pretreating a wastewater to remove precipitable materials harmful to reverse osmosis membranes; and
purifying the wastewater using reverse osmosis,
wherein said pretreating step include adding a flocculating agent to the wastewater to form precipitated particles and removing the precipitated particles from the wastewater by filtration.
